(19) United States
(12) Patent Application Publication
(10) Pub. No.: US 2008/0050540 A1
(43) Pub. Date: Feb. 28, 2008

(54) Thermochromic display assembly

(76) Inventors: Peter Christofer, Manhasset, NY (US); Brian Schlessinger, River Vale, NJ (US)

Correspondence Address: Marlana Titus;Nash & Titus, LLC, 6005 Riggs Road, Laytonsville, MD, 20882, US

(21) Appl. No.: 11/508,571

(22) Filed: Aug. 23, 2006

(51) Int. Cl. B32B 3/10; B44C 5/00; B41M 5/00; B05D 1/32; B05D 1/36

(52) U.S. Cl. 428/13; 428/195.1; 427/402; 427/282

(57) ABSTRACT

This invention encompasses display arrangements and assemblies having multiple layers. The base layer has a color image of non-thermochromic ink, a second layer includes a thermochromic ink, and a third layer includes a thermochromic ink forming an image visible on top of the second layer. The second and third layers largely mask the non-thermochromic ink from view. Cut-out stenciled images are cut through the second and third layer so that the non-thermochromic colors of the base layer are visible through them. At a lower temperature, the thermochromic inks are visible as well as the non-thermochromic ink colors through the cut-out stenciled image areas. At a higher, color-changing temperature, the thermochromic inks become sufficiently transparent that the non-thermochromic colors of the base layer are visible.

### FIELD OF THE INVENTION

This invention relates to a display assembly having a unique ornamentation effect. The display arrangement makes use of both thermochromic and non-thermochromic colors to display reversible color images that are different at different temperatures.

### BACKGROUND OF THE INVENTION

The novelty and collectibles market thrives on innovation, fun and cutting edge aesthetic designs. Decorative display items are consistently in demand as gift items, decor, collectibles, seasonal and religious merchandise and the like.

Consumer product display items including thermochromic or thermally color-changing inks are known. However, displays that are fully aesthetically appealing at both hot and cold states are not well known. Currently known display items using thermochromic inks generally have colorful images at elevated temperatures, but at cold or ambient temperature are limited to a dark and unappealing image, or no image at all.

### SUMMARY OF THE INVENTION

This invention is based on the discovery how to display at least two aesthetically appealing images at different temperatures, such as at a lower temperature and at an elevated temperature, combining both thermochromic and non-thermochromic ink, and traditional printing techniques such as silkscreening and offset printing methodology. In particular, the inventors have created a visual display that shows one color image at a lower temperature (e.g., ambient or room temperature) and a different color image when exposed to higher temperatures. The images can be any desired image or picture, depending on the desired purpose or theme, including seasonal, holiday, special event, religious, cultural, etc.—but the mechanics of the display and the way it is used remain fairly consistent.

For the purposes of this invention, the term thermochromic ink denotes inks that change color or become transparent when exposed to certain temperatures. For instance, some thermochromic inks change color or become transparent when the temperature is elevated, or when the temperature decreases. Thermochromic inks are well known and available, and a detailed explanation of their chemistry and manufacture is not needed. One manufacturer of thermochromic inks is Pilot Ink, located in Japan.

In particular, our invention entails a display arrangement, which includes at least three layers. The first or bottom layer is a substrate on which is one and preferably two, three, four or more colors of non-thermochromic ink, in desired areas, and will preferably include a color image. The substrate may be any material that supports additional layers, is capable of accepting ink, and does not melt or burn when exposed to heat. The substrate may be as simple as standard paper. Preferably, however, the substrate is made of polyvinyl chloride, because it is commonly used when making a sticker—that is, it preferably has an adhesive on the back of it (and optionally a release liner for applying the adhesive to a surface). Another preferred embodiment is that the base layer may be pasted onto a surface, or otherwise be attachable to a surface as desired and depending on the end use of the product. The non-thermochromic color or colors do not change when the temperature immediately surrounding them changes—that is, at lower temperature (e.g., ambient or room temperature) the color or colors are the same as at higher temperatures, under normal usage.

For the purposes of this invention, “lower temperature” or “first temperature” denotes a temperature whereby the thermochromic ink is visible to the naked eye, when contrasted to a “higher temperature” or “second temperature” where the thermochromic ink begins to become transparent to the naked eye. Thus, “lower temperature” or “first temperature” includes any temperature below the temperature at which a chosen thermochromic ink begins to become visible or otherwise changed color. Preferably, the lower temperature will be ambient or room temperature since this is convenient for the consumer gift and novelty item uses of this invention, although any lower temperature may be contemplated depending on the higher temperature at which the thermochromic inks begin to become transparent. Similarly, “higher temperature”, “second temperature”, or “elevated temperature”, or the like, denotes the temperature at which the thermochromic inks begin to become transparent. This higher temperature will depend on the particular thermochromic ink(s) chosen, as such inks have various color-changing temperatures. Someone having ordinary skill in this art can readily chose the thermochromic ink or inks desired at the color-changing temperature desired, depending on the end use desired. For the purposes of this invention, it is generally preferred that all of the thermochromic inks used share the same or similar color-changing temperature, so that once that temperature is reached they all begin to become transparent nearly simultaneously. Where the end use of the invention is a consumer gift or novelty item, intended for consumption by the general public, it is convenient to choose thermochromic inks that begin to change colors or become transparent between about 77° F. to about 85° F. This is because the time needed to elevate the temperature to about 77° F. to about 85° F., using a common heat source such as a candle (although any heat-generating source would be acceptable for the purposes of this invention), is relatively short and convenient—usually less than two minutes after the display arrangement is exposed to heat. However, we emphasize that the lower and higher temperatures, and time needed for the thermochromic inks to change colors, may vary as the desired end use dictates, as would be understood by someone having ordinary skill in this art.

Thus, the first or bottom layer will have one or more colors either entirely covering the substrate or located in strategic places as desired (which may depend on where cut-out stencils or drop-out silkscreening are desired to be located, as described below). In addition, and preferred, a non-thermochromic color image is positioned onto the substrate. Preferably the one or more colors and/or the color image include two, three, four, or even more colors, as this significantly improves the aesthetic appeal of this layer. Four colors are preferred since this generally gives a pleasing image at a reasonable cost. However, as many colors as desired may be included.

Preferably, in this first layer the one or more colors and/or the color image are applied to the substrate by color process offset printing (e.g., four-color process offset printing), methods of which are well-known to printers and other persons having ordinary skill in this art. The one or more colors and/or the color image of this first layer may be applied by other known methods, but process offset printing is generally considered to be the most efficient.

A second layer is positioned on top of the first or bottom layer, which comprises obscuring thermochromic ink. By “obscuring thermochromic ink”, it is meant that the ink is sufficiently opaque so as to mask or at least partially hide the one or more colors and the color image of the first layer at lower temperatures, either alone or when combined with a third layer (as described below). Preferably, the ink is a single color, such as black or red or dark-brown or blue-green, although any color will work as long as it is opaque enough to conceal or at least partially hide the colors of the first layer at lower temperature. It is possible to use more than one color, but this generally increases the cost of production. Often the choice of color will depend on the colors chosen for a third layer, as described below. Thus, the purpose of this second layer is to facilitate masking the color and color image of the first layer, at lower temperatures. It is not necessary that this obscuring thermochromic ink layer completely mask the color and/or color image by itself, although it may. When combined with a third layer, as described just below, the color and/or color image of the first layer will be significantly and preferably fully masked from view at lower temperatures.

Preferably, the thermochromic ink is applied to the second layer by silkscreening techniques, methods of which are well-known to printers and other persons having ordinary skill in this art.

A third layer is positioned on top of the second layer, which comprises thermochromic ink of at least one color—but in some embodiments, preferably at least two colors—other than the color of thermochromic ink(s) of the second layer. It is important that the one or more colors on this third layer show up as visible at lower temperatures over against the obscuring (and usually dark) background of the second layer beneath it. Any color may be used for that purpose—light or dark—but preferably the colors are aesthetically pleasing against the obscuring second layer. It is often most practical that the second layer comprise black or dark brown colored ink, and the third layer include brighter-colored ink which contrast nicely with the second layer. Examples of such colors would be red, blue, brown, charcoal gray, purple, green, orange, and shades thereof. Preferably, the third layer ink is opaque enough to conceal the colors of the first layer at lower temperature, especially when combined with the second layer. It is more preferred that the obscuring thermochromic ink of the second layer and the thermochromic inks of the third layer in combination are sufficient to mask from visibility at lower temperature at least a significant portion, and preferably all, of the color image of the first layer.

To maximize the aesthetic appeal, the one or more colors of the third layer are applied so as to make a desired image or picture. This is one of the advantages of this invention, that the third layer include an image that is visible at lower temperatures. To that end, it is preferable that the third layer include two, three, four or more colors. Four colors are preferred since this generally gives a pleasing image at a reasonable cost. However, as many colors as desired may be included. Preferably the colors include at least blue and red since these are popular colors and show up well against a dark-colored second layer.

Preferably, the thermochromic inks are applied to the third layer by silkscreening techniques, methods of which are well-known to printers and other persons having ordinary skill in this art. As is common with silkscreening, each color of this third layer is applied separately.

A unique feature of this invention is at least one cut-out stencil or drop-out silkscreening used in conjunction with thermochromic ink. “Cut-out stencil” and “drop-out silkscreening” (hereafter referred to simply as cut-out stenciled images) denotes the feature where the second and third layers have corresponding stenciled images cut or mortised through them during or after assembly, so that after the display is assembled at least part of the first layer including one or more non-thermochromic colors is visible through the cut-out stenciled images at a lower temperature. In other words, the design that is desired to be exposed through the top layers and viewed at lower temperatures is masked out. In one embodiment, the thermochromic inks of the third layer do not entirely cover the second layer—for instance, where an image is silkscreened on top of the second layer but that image does not cover the whole of the second layer, thus leaving areas where only the second layer need by cut through to make the stencil. In another variation, the entire second layer is covered by the thermochromic inks of the third layer—in other words, the colors of the first layer show through the second and third layers where the cut-out stenciled images are, making the images prominent in relief next to the thermochromic inks of the second and third layers. Thus, at lower temperatures, to the naked eye the display arrangement will show the cut-out stenciled images “against” (that is, next to) the background of (that is, surrounded by) the second and third layers (especially the second layer, which is preferably black or at least dark).

With this feature, at lower temperatures at least one aesthetically pleasing cut-out stenciled image is visible, the colors of which are the non-thermochromic inks of the first layer. Simultaneously visible at lower temperatures are the thermochromic inks of the third layer. In this way, at lower temperatures a very pleasing display is visible, made up of a combination of the cut-out stenciled image showing the mono- or multi-colors of the non-thermochromic inks of the first layer, and the mono- or multicolored image of the third layer thermochromic inks. However, at lower temperatures the color image of the first layer will be at least significantly, but preferably fully, masked. This is referred to herein as “the low temperature display” or the “cold state display”.

At higher temperatures, what is visible to the naked eye changes due to the nature of the thermochromic inks. When the temperature is elevated (such as by, for instance, exposure to heat from a candle) the thermochromic inks of both the second and third layers “disappear” or otherwise fade and become transparent. As a result, the cut-out stenciled image correspondingly is no longer visible in its original configuration (i.e., as cut-out images). That is, since the edges of the cut-out stenciled image are formed of the thermochromic ink of at the second and third layers, at higher temperatures the thermochromic ink edges disappear so that the cut-out stenciled image gives the impression of also disappearing. The color(s) of the first layer at the position of the cut-out stenciled images remains visible—since that color is non-thermochromic ink—but is of course no longer outlined by the edges of the cut-out stenciled image.

When the display arrangement is exposed to heat so that the temperature is sufficiently elevated, the thermochromic inks of the second and third layers “disappear” or otherwise fade and becomes transparent. As described above, the result of this is that the colored image of the third layer is no longer visible and the cut-out stenciled image correspondingly is no longer visible in its original configuration. However, the color image of the first layer becomes at least partially, and preferably fully, visible. As long as the temperature is sufficiently elevated, the thermochromic inks remain transparent and the color image of the first layer is visible. This is referred to herein as “the higher temperature display” or the “hot state display”.

Another feature of this display arrangement is that the cold state and hot state displays are repeatedly reversible, as the temperatures cool or are raised again. When the display arrangement is allowed to cool to the lower temperature the color image of the first layer is again masked by the thermochromic inks of the second and third layers, the thermochromic ink image of the third layer is again visible, and the cut-out stenciled images are again visible in their original configuration—that is, with the edges of the image visible by virtue of the thermochromic ink being visible and covering all of the colors of the first layer except where the cut-out stenciled image is positioned.

Preferably, the thermochromic inks of both the second and third layers are chosen or calibrated so that they become transparent at the same or similar higher temperatures. As noted above, it is generally preferred that where the end use of the invention is a consumer gift or novelty item, it is convenient to choose thermochromic inks that begin to change colors or become transparent between about 77° F. to about 85° F. Also, it is possible that the various thermochromic inks of the second and third layers have different temperatures where color change takes place—for instance, at temperature T¹ the thermochromic inks of third layer change color and become transparent, and at temperature T² the thermochromic inks of the second layer change color and become transparent. Or the various colored thermochromic inks of the third layer may each have different temperatures where they become transparent, giving the appearance of gradual fading out of the third layer image as the temperature increases. As someone having ordinary skill in this art would be aware, given the known thermochromic inks available, it is possible to calibrate the color-changing of the inks at different temperatures as preferred. This again depends on the desired end use.

Besides the first, second and third layers, additional layers are possible. For instance, a film seal is preferably positioned on top of the third layer to protect the display assembly. The film seal may be made of plastic or any material that is transparent and once applied will seal the top layer protectively. Or additional layers of thermochromic ink may be added to make the image design visible at lower temperatures more brilliant. Thus, a fourth, fifth layer, or more, is also contemplated with this display arrangement.

In another preferred embodiment, the display arrangement is combined with other elements to form a display assembly. The display assembly may comprise a support which can be made of any material that can support the display arrangement, does not conduct significant amounts of heat and does not burn or melt easily. Preferably the support is shaped in the form of a predetermined object. This support is preferably formed of cold cast resin or ceramic, glass or composites of these materials. The support has a display region on which may be attached (releasably or permanently) or positioned the display arrangement, such as described above, and a heat source area positioned below the display region (and consequently the display arrangement). The heat source area is shaped to receive a heat source. The display assembly may further include the heat source itself, such as a candle or other appropriate heat-generating resource or supply. The heat source may be electric, butane, propane, gas-powered, or use any known fuel. Optionally, heat conductors may be included to conduct heat as desired, placed between the heat source and the display region. Possible heat conductors include metal plates, or non-flammable conducting materials. In the arena of novelty or gift items or collectibles, the support may preferably be shaped according to any theme or purpose related to the color image of the first layer, and the cut-out stenciled images.

For instance, following a Christmas holiday theme, the support may be in the form of a miniature fireplace and mantle, where the heat source (e.g., a small candle) is placed in the fireplace area, and above the mantle (i.e., above the heat source) the display region and display arrangement are positioned. The cut-out stenciled images may form words such as “Season's Greetings”, visible at ambient temperature; and when the candle is lit the temperature becomes elevated so that the thermochomic inks become transparent and the color image of the first layer is revealed—for instance, a picture of a jolly Santa Claus.

In another related embodiment, there is contemplated a method of operating the above-described display assembly. The assembly is designed for easy and safe consumer use, especially when the end-use is a gift or novelty item. The basic method comprises the step of causing heat to be emitted from the heat source so as to heat the display region and consequently the display arrangement. This exposes the thermochromic inks of the second and third layers to sufficient heat so as to reach the color-changing temperature. As a result, the thermochromic inks become sufficiently transparent that (1) the color image made by the thermochromic inks of the third layer is not visible, (2) the cut-out stenciled images become no longer visible in their original configuration as cut-out images, and (3) and the non-thermochromic color image of the first layer becomes at least partially, and preferably fully, visible. There may be the additional step of cooling the heat source, which reverses the process, thereby allowing the display region to cool to lower temperature so that (1) the thermochromic inks of the second and third layers become again visible, (2) the cut-out stenciled images again become visible in their original configuration as cut-out images, and (3) the color image of the second layer is again masked from visibility.

Any thermochromic inks can be used with this invention, as long as they are able to function in the manner described above. Preferably, the thermochromic inks remain stable (i.e., do not begin to change color or become transparent) until about 71° F. A temperature as low as 66° F. is possible for color change to begin, although this is generally not practical for consumer use if the end-product is a gift or novelty item. Preferably, color change is completed at about temperatures less than 87° F. More preferably, the thermochromic inks do not begin to change color until around 76° F.-80° F., and color change is completed at around 87° F. In general, no temperature is too high or too low, with the caveat that if a temperature becomes too hot the time needed for the thermochromic inks to cool back to the lower temperature is undesirably long, or even that the substrate of the first layer may melt or burn. The temperature range is dictated by what would be most convenient and safe for the consumer user. Usually, a small candle is sufficient to generate adequate heat, where the thermochromic inks are calibrated to change color beginning at 76° F.-80° F., and color change is completed at around 87° F. The time needed for complete color change depends on the heat conductivity of the display assembly and its ability to capture heat—which variables are easily controlled and set by someone of ordinary skill in this art using known methods. Preferably, when the end-product is a consumer gift or novelty item, the color change is usually completed in less than two minutes.

To that end, when the end-product is a consumer gift or novelty item, it is preferable that the heat source heats the display arrangement to a temperature of between 71° F. to 87° F., and preferably between 73° F. to 87° F., and more preferably between 76° F.-87° F.

In another embodiment, this invention entails methods of making the above-described display arrangement. In one such method, the steps comprise a first step of forming a base or first layer by applying one or more colors and/or a color image of non-thermochromic ink onto a support substrate capable of accepting ink. Preferably, in this base or first layer the one or more colors and/or the color image are applied to the substrate by color process offset printing (e.g., four-color process offset printing), also known as ultraviolet printing, methods of which are well-known to printers and other persons having ordinary skill in this art.

A second step entails applying over the base layer obscuring thermochromic ink, such as described above, to form a second layer. In particular, the thermochromic ink is applied by well-known silkscreening techniques. Preferably, a screen of 150 mesh is used (i.e., 150 openings per square inch of the mesh, which openings allow the ink to pass through as desired), although the screen may have mesh openings as low as 75 per square inch. As is known in the arena of printing art, the denser the mesh, the finer the image silkscreened. The screen mesh can be chosen as desired.

A third step entails applying over the second layer thermochromic ink of at least one color (and in some embodiments, at least two colors) other than the color of the thermochromic ink of the second layer, such as described above, to form a third layer. Again, preferably the thermochromic ink is applied by well-known silkscreening techniques. The obscuring thermochromic ink of the second layer and the thermochromic ink(s) of the third layer are applied in such as way so that, in combination, they are sufficient to mask from visibility at lower temperature the color image of the first layer.

A fourth step entails cutting out or mortising at least one stenciled image through the second and third layers so that at least part of the first layer including one or more colors is visible at lower temperatures through the at least one cut-out stenciled image, such as described above. Stenciling, or drop-out silkscreening, may be done by known techniques. In general, using methods known in the printing arts, drop-out silkscreening is carried out under conditions where ink is not printed on that area where the stencil cut-out is positioned, and in the finished assembly the first or bottom layer is exposed through the second and third layers at the position of the stencil cut-out. For example, the display arrangement may be assembled, then the stencil image may be drawn onto the third layer, and the image is cut out or mortised using known computer software (such as Photoshop by Microsoft or Quark by Adobe, or other known software suitable for silkscreen applications).

Preferably, the second and third layers are allowed to dry completely in between steps.

In our method for making the display arrangement, it is optional to more layers of thermochromic ink. Thus, a fourth, fifth layer, or more, is also contemplated with these methods.

Furthermore, it is preferable that a film seal is positioned on top of the third layer, or some other protective layer, to protect the display arrangement and the integrity of the various inks.

Preferably, the display arrangement is then attached to a support shaped in the form of a predetermined object, such as is described above, which support has a heat source area positioned below the display arrangement, which heat source area is shaped to receive a heat source. Attachment may be by adhesive, tape, glue or any known means.

### BRIEF DESCRIPTION OF THE DRAWING

The manner in which the invention can be implemented and the advantages which derive therefrom will emerge more clearly from the exemplary embodiments which follow and which are given by way of illustration and as non-limiting examples with reference to the figures attached and described below. The lines in these figures are not to be taken as designating any specific color because the thermochromic ink compositions used with the invention may constitute various colors.

FIG. 1 shows the respective layers of the display arrangement, illustrating one embodiment of the invention.

FIG. 2 shows one embodiment of the display arrangement, as images might be visible at lower temperatures or in the cold state. The images reflect the visible thermochromic inks of the third and optionally the second layer, where the color image of the first layer is fully masked.

FIG. 3 shows an embodiment of the display arrangement, such as it might be visible at higher temperatures or in the hot state after the display arrangement of FIG. 2 is exposed to heat and the thermochromic inks of the second and third layers have become transparent, thereby unmasking the non-thermochromic inks of the first layer.

FIG. 4 shows another embodiment of the display arrangement, as images might be seen at lower temperatures or in the cold state. The images reflect the visible thermochromic inks of the third and optionally the second layer, where the color image of the first layer is fully masked.

FIG. 5 shows an embodiment of the display arrangement, such as it might be visible at higher temperatures or in the hot state after the display arrangement of FIG. 4 is exposed to heat and the thermochromic inks of the second and third layers have become transparent, thereby unmasking the non-thermochromic inks of the first layer.

FIG. 6 shows yet another embodiment of the display arrangement, as images might be seen at lower temperatures or in the cold state. The images reflect the visible thermochromic inks of the third and optionally the second layer, where the color image of the first layer is fully masked.

FIG. 7 shows an embodiment of the display arrangement, such as it might be visible at higher temperatures or in the hot state after the display arrangement of FIG. 6 is exposed to heat and the thermochromic inks of the second and third layers have become transparent, thereby unmasking the non-thermochromic inks of the first layer.

FIG. 8 shows yet another embodiment of the display arrangement, as images might be seen at lower temperatures or in the cold state. The images reflect the visible thermochromic inks of the third and optionally the second layer, where the color image of the first layer is fully masked.

FIG. 9 shows an embodiment of the display arrangement, such as it might be visible at higher temperatures or in the hot state after the display arrangement of FIG. 8 is exposed to heat and the thermochromic inks of the second and third layers have become transparent, thereby unmasking the non-thermochromic inks of the first layer.

FIG. 10 shows one embodiment of the display assembly, with a support structure, a display region, and a heat source (a candle). In FIG. 10A, the display region shows the visible images of the thermochromic inks at lower temperatures or in the cold state (unlit candle). In FIG. 10B, the display region shows the heat source (a lit candle), and the visible images of the non-thermochromic inks at higher temperatures or in the hot state.

FIG. 11 shows another embodiment of the display assembly, with a support structure, a display region, and a heat source (a candle). In FIG. 11A, the display region shows the visible images of the thermochromic inks at lower temperatures or in the cold state (unlit candle). In FIG. 11B, the display region shows the heat source (a lit candle), and the visible images of the non-thermochromic inks at higher temperatures or in the hot state.

FIG. 12 shows one embodiment of the display assembly, with a support structure, a display region, and a heat source (a candle). In FIG. 12A, the display region shows the visible images of the thermochromic inks at lower temperatures or in the cold state (unlit candle). In FIG. 12B, the display region shows the heat source (a lit candle), and the visible images of the non-thermochromic inks at higher temperatures or in the hot state.

FIG. 13 shows one embodiment of the display assembly, with a support structure, a display region, and a heat source (a candle). In FIG. 13A, the display region shows the visible images of the thermochromic inks at lower temperatures or in the cold state (unlit candle). In FIG. 13B, the display region shows the heat source (a lit candle), and the visible images of the non-thermochromic inks at higher temperatures or in the hot state.

As is apparent to someone having ordinary skill in this art, the various figures are intended to designate for explanatory purposes various different display arrangements and display assemblies contemplated by this invention. The display arrangements and assemblies shown are considered to embody concepts as are set forth and defined in the appended claims. From a consideration of this entire specification it will be realized that these concepts can be employed in a wide variety of diverse pictures, patterns, signs and the like through the use or exercise of routine artistic or design skill.

### DETAILED DESCRIPTION OF THE PREFERRED EMBODIMENTS

We have described display arrangements that change appearance upon changes in temperature. Our display arrangements uniquely combine both thermochromic and non-thermochromic inks that visualize colors, patterns and images at lower temperatures, and at higher temperatures show a different set of colors, patterns and images as the thermochromic inks change color or become transparent—thus, the images vary at cold state and hot state temperatures. These display arrangements and display assemblies are visually pleasing at all temperatures, simple to use, and interesting to observe change appearance.

The term “display arrangement” is used in connection with our invention to denote a layered composite structure or article which conveys a visual design, message or graphics image, including any sort of a pattern or picture. As is apparent from the examples and our description, there is a broad range of possible visual designs and effects that can be displayed, both in the cold state and the hot state. Virtually any design or picture or image can be displayed as long as it is printable or otherwise expressible onto the substrates described herein using the mediums described herein. The figures describe only a few of the possible designs and visual effects, as would be understood by someone having ordinary skill in the art.

Our invention in all of its embodiments is capable of being operated either manually and simply, for instance by the use of a candle (where the lower temperature is ambient temperature and the candle's heat is sufficient to effect a higher, color-changing temperature), or through the use of more complicated temperature controlling means, such as electronic controlled, or other power-generating means.

Thermochromic inks of the type that can be used in all of the embodiments of our invention are well known. The term “thermochromic” as used in connection with our invention designates a characteristic or property of a material or composition useful as an ink, dye or printing pigment materials, which characteristic or property causes the material or composition to visually appear as being of one color at one temperature and another color at another temperature. That is, thermochromic substances are those that change color in response to a change in temperature. It may be conveniently applied as a coating over the graphics images or colors which are printed on the base layer, so as to mask the underlying graphics pattern at temperatures below the transition (i.e., color-changing) temperature (such as room temperature conditions, generally between 68° F. to 80° F.).

In the art, the terms “thermally color-changing material”, “thermotropically colored material”, “thermochromatic” and “chromo-thermosensitive material” are sometimes used synonymously with “thermochromic” as it is intended to be used here.

Thermochromic ink compositions of the type used with our invention are reversible. That is, reversible thermochromic inks change from one color to another and then back again as they are heated and cooled. Reversible thermochromic inks are known (see U.S. Pat. No. 4,028,118), and printing inks prepared from these inks have been applied to various articles to construct items including ornamental objects that reversibly change or develop color at well-defined temperatures. Generally, the temperature at which the thermochromic inks change color can range anywhere between 0° C. to 100° C.

Different thermochromic inks (in different colors, for example) can have different transition temperatures. Thermochromic inks are disclosed in U.S. Pat. No. 5,202,677, U.S. Pat. No. 5,805,245, and U.S. Pat. No. 5,223,958, which are incorporated herein by reference. Such thermochromic inks and printing compositions as are contemplated by our invention are commercially available. For instance, a leading company providing such thermochromic inks is Pilot Ink, located in Japan.

An understanding of the subject matter of our invention in every embodiment does not require a detailed explanation of the nature of thermochromic inks. Our invention relates to the use of known thermochromic substances in connection with various types of display arrangements so as to achieve temperature-driven changes in the appearances of such display arrangements which are visually stimulating and/or aesthetically appealing.

The non-thermochromic inks used to make up the color or colors of the base layer, including the color image, may be of any type presently known. The only requirement is that the non-thermochromic inks are able to be accepted by the substrate to make a desired pattern or image, may be substantially masked from visibility by the thermochromic inks or the second and or third layers, and do not change color as the temperature changes (i.e., are stable at both the hot and cold states). Standard printing inks are generally quite adequate for the purposes of this invention, and n understanding of the subject matter of our invention in every embodiment does not require a detailed explanation of the nature of non-thermochromic inks.

Regarding the base layer, any material including a sheet that has good receptivity to ink or the like may be effectively used as the substrate in the base layer. It should be a material that supports additional layers (such as layers of inks, film sealing, etc.) and does not easily melt or burn when exposed to heat. As noted above, the substrate may be as simple as standard stock paper. Polyvinyl chloride is a preferred substrate, since it can be used as a decal, where one side has the non-thermochromic and thermochromic layers of ink, and the reverse side has an adhesive on it (and optionally a release liner for applying the adhesive to a surface). Materials which are white or pale in color are preferred since they facilitate the viewing of images of various colors. In one preferred embodiment, the display assembly without the support or means of support is in the form of a decal, which has the non-thermochromic and thermochromic layers of ink on a first side, and optionally on the reverse side has an adhesive on it (with an optional release liner for applying the adhesive to a surface, such as a surface on the support).

Regarding the support of the display assembly, it may be made of any material that can support the display assembly and include a heat source area. Preferably, the material is of a type that is pliable or otherwise may be constructed or molded into any desired form. Cold cast resin is the material preferred, since it is commercially available, can be shaped into virtually any shape desired, is strong enough to support the display assembly and heat source area, does not conduct substantial amounts of heat, and is stable in the hot state and the cold state. Supports made by cold cast resin may be made using standard cold cast molding techniques. However, other materials may be used to make the support, such as for example ceramic, glass or composites of these materials.

When the end use is a consumer gift or novelty item, it is convenient that the heat source is a candle. However, any appropriate heat-generating resource or supply may be used, depending on the intended end use and the desired color-changing temperature, as would be understood by someone having ordinary skill in this art. The minimum requirement of the heat source is that it is capable of generating sufficient heat to reach the color-changing temperature or higher temperature, as defined herein. For instance, the heat source may be electric, butane, propane, gas-powered, or use any known fuel. Preferably the heat source is easily controllable and relatively safe for consumer use. Optionally, heat conductors may be included to conduct heat as desired, placed between the heat source and the display region. Possible heat conductors include metal plates, or other heat-conducting non-flammable materials. It is understood that our display arrangements may include any known means for regulating the temperatures of the area of the display arrangement so as to effect color changes in the thermochromic inks.

As described above, using the display arrangement is as simple as effecting a change of temperature from the cold state to the hot state, so that the thermochromic inks of the second and third layers become transparent enough that the non-thermochromic inks of the first layer are unmasked or otherwise exposed. In the context of the display assembly, in its simplest form, the basic steps for operation are causing heat to be emitted from the heat source so as to heat the display region, and consequently the display arrangement, to the color-changing temperature, and optionally, cooling the display arrangement (either by simply extinguishing the heat source or otherwise actively cooling the display arrangement) to reverse the color-change.

The display arrangement may be made using known techniques of printing, preferably including silkscreening methods. By “silkscreening”, it is meant screen printing as known in the art. An understanding of the subject matter of our invention in every embodiment does not require a detailed explanation here of the known techniques of silkscreening, offset printing or drop-out silkscreening.

In general, for silkscreen printing a rigid frame (wood or metal or as desired) serves as a printing form, with a fabric mesh screen stretched across one side. For the printing process the printer covers any areas of the screen where ink is not intended to penetrate. That is, the areas that are not to be printed are masked out on the screen (hence, drop-out silkscreening). The item being silkscreened (i.e., the base layer) is put underneath the screen and the screen is covered with a little ink of the desired color, which is spread by means of a squeegee, a handle with a rubber edge, a doctor blade or the like. Pressure is exerted onto the ink which causes it to flow through the open mesh parts in the screen, and is then evenly spread on the base layer underneath. The masked areas prevent ink from passing through, but the unmasked areas allow the ink to be imprinted on the base layer. The silkscreened item is allowed to dry or cure, which may be done by any known means. For instance, the item may be placed on a conveyor belt through a heat-tunnel. This curing process ensures that the inks dry quickly. Properly cured inks will remain on the printed substrate even under harsh conditions.

For each new ink color, a new screen is needed and the process is repeated until the final design is finished. In other words, a design that requires four different colors would require four different screens. For convenience, the screens may be placed on a rotary press which allows the different color prints to be properly aligned or registered with each other. Some screen-printers have fully automatic presses that do not require any manual labor other than set-up and loading/unloading.

There are known methods for masking a screen to accomplish drop-out screening or cut-out stenciling of images. One convenient way is to apply masking fluid directly on the screen. This technique may be suitable for simple one or two color graphic designs but is less desirable for more complex prints. For designs having more than two colors, photosensitive emulsions are useful to create the masked areas. For this, the design is first created on a clear piece of plastic film. A photosensitive coating is applied to the entire surface of the screen and then dried. The film is placed on the prepared screen and exposed to bright light. After a period of time, the exposed areas can be washed off the screen with water which makes the screen ready to print.

Persons having ordinary skill in this art, using standard methods of offset printing, silkscreening, and drop-out silkscreening, would be able to make and use this invention. For instance, in our invention, to make the base layer a non-thermochromic color image is applied to a substrate such as is described above. For example, using standard offset printing methods a multi-color image (generally including as many or as few colors as desired or economically practical) is printed onto the surface of a blank polyvinyl chloride substrate sheet, which preferably has an adhesive on the back of it with a releasable backing. Preferably, well-known four-color offset printing technology is used, where virtually any color desired can be printed onto the base using four standard colors (e.g., magenta, yellow, black and blue). In general, offset presses have three printing cylinders—plate, blanket and impression. The plate cylinder rotates to come into contact with a dampening roller and then an inking roller. The dampening roller wets the plate to the non-printing areas repel ink, and the inked image may then transfer to the blanket cylinder where the printing substrate is printed on as it passes between the blanket and impression cylinders.

Other known methods besides offset printing may be used to print the non-thermochromic inks onto the base layer, such as silkscreening, letter pressing, or roto-gravure. Direct digital process is also an option, which eliminates the need for a film step, so that the image is directly printed. However, in general, offset printing is most convenient. After the non-thermochromic inks are applied, the base layer is allowed to dry.

Usually prior to the application of the second and third layers, drop-out images (also called cut-out stenciled images herein) are cut out. This is done by known methods in the art, and may also be referred to as drop-out silkscreening or drop-out screening. An image is selected and prepared using printing software such as described above. The image is put in reproducible format, and a silkscreen plate is made accordingly. In general, the image or art used is camera ready. In this feature, silkscreening is a form of stenciling, in that certain areas are masked and other areas are cut out. The cut out areas then have the ink dispersed on to the substrate below. The entire silkscreen plate is flooded with one color of ink and in the cut out areas the ink is prevented from flooding. Here, drop-out silkscreening differs from regular silkscreening in that no screens are used—rather, opaque images are laid down to mask are area and prevent the flooding ink to contact that area. Standard silkscreening uses a screen to allow the inks to pass through selectively—the printed image is produced by blocking holes or pores of the screen representing the non-printing areas.

The second layer is applied by silkscreening or screen printing a desired mesh (e.g., 150 mesh) of obscuring thermochromic ink (preferably black) as described above over the color image of the base layer. Drying time for this stage may be approximately half of a day. Then the third layer is applied, which comprises silkscreening additional layers of thermochromic inks in various desired colors, other than the color of the second layer. As noted above, the second and third layers need to be darker than the color image of the first layer—otherwise, the colors of the first layer will “bleed” through and be visible in the cold state. The number of colors for this third layer may be as many as desired, but for reasonable aesthetic appeal at a reasonable cost, it is usually preferred that one to four colors be applied, and more preferably two to four colors. Each color is applied separately, usually by silkscreening and then drying before the next color is applied. The colors of this third layer are preferably applied so as to display a design or pattern in the cold state.

Preferably, the thermochromic color image area is film sealed for protection.

To make the support element a mold is made of a desired form—for example, a mold is sculpted that resin for cold casting can be poured therein to create the support.

More specific examples of the display of the present invention will now be described in conjunction with the figures.

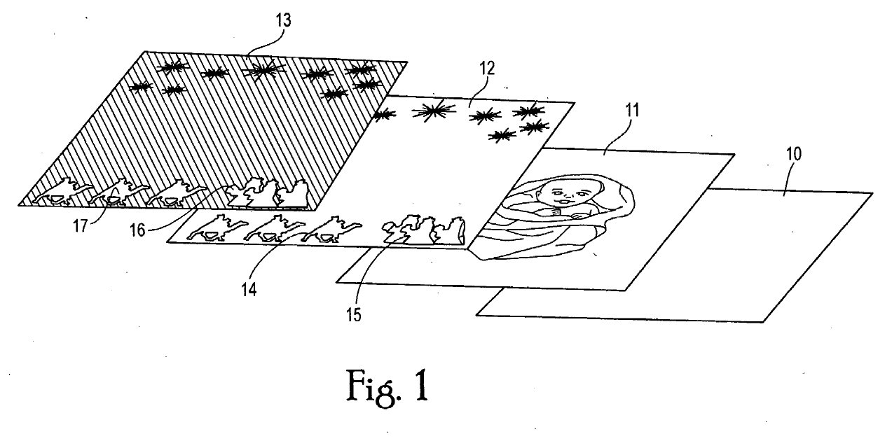

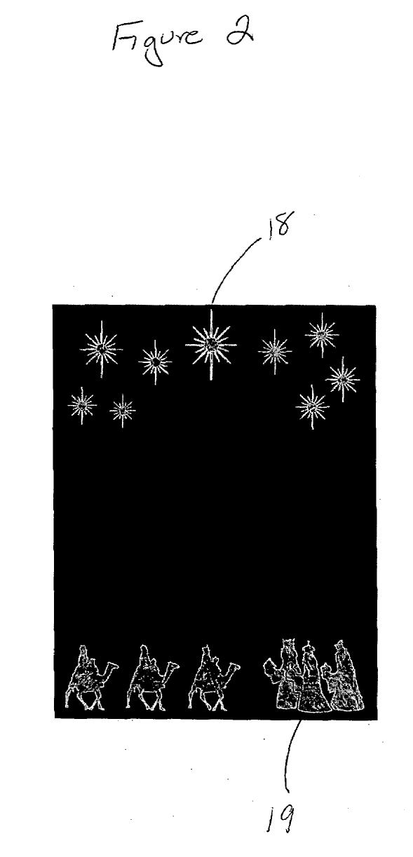

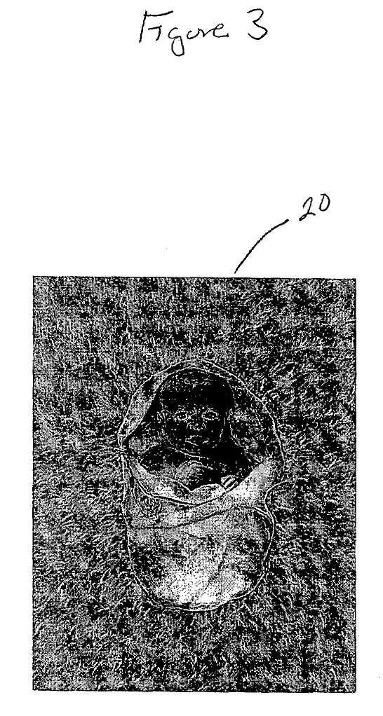

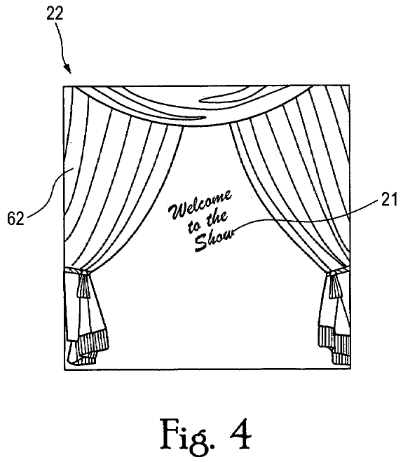

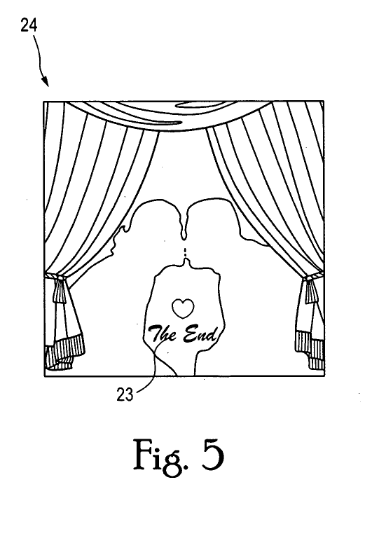

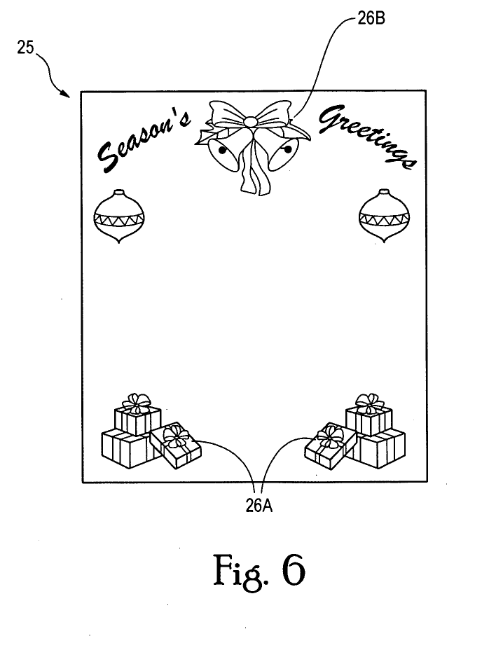

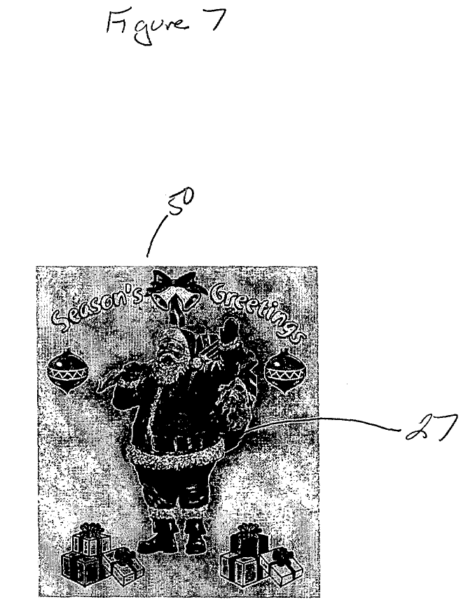

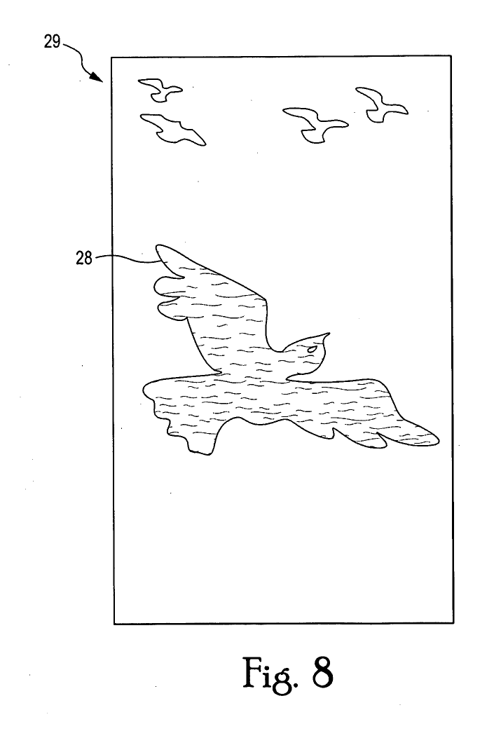

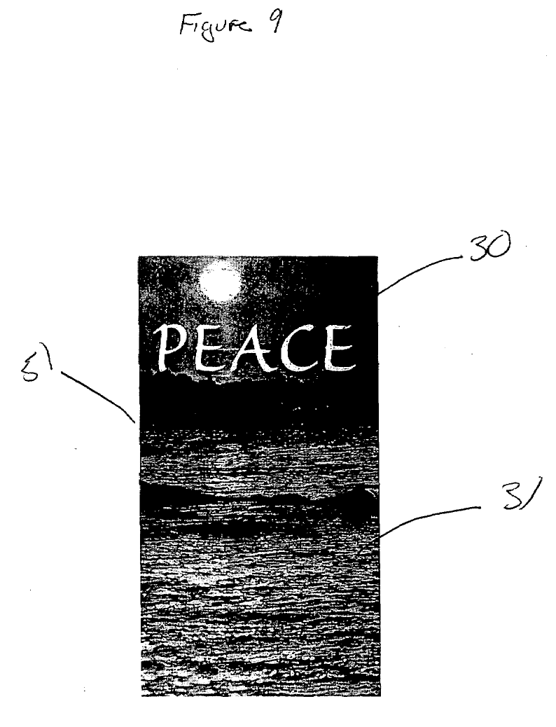

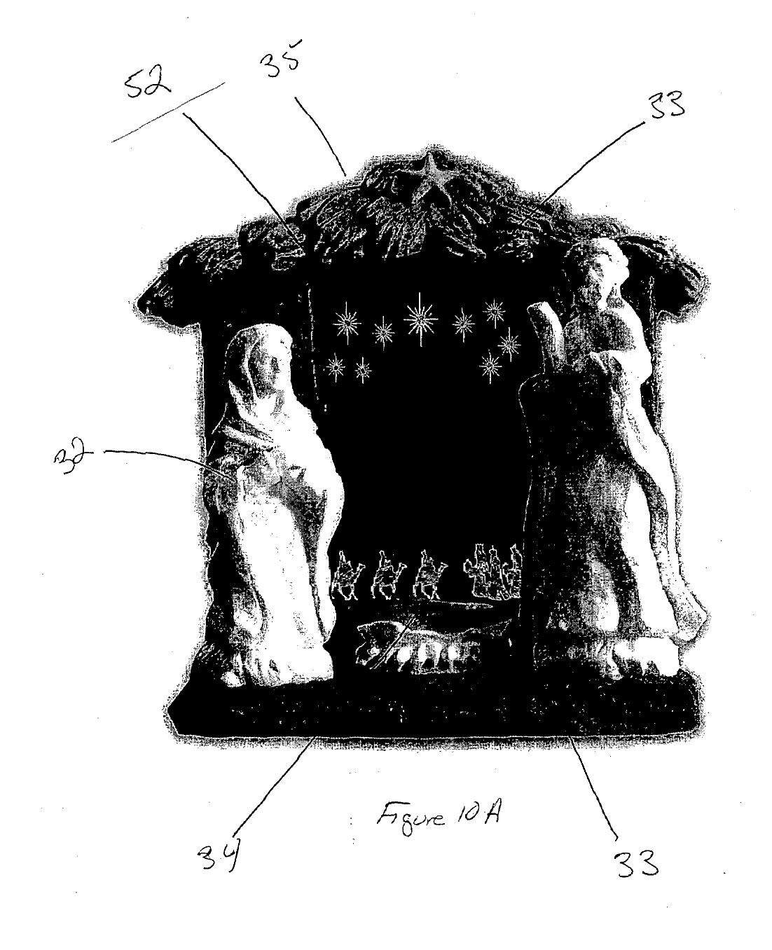

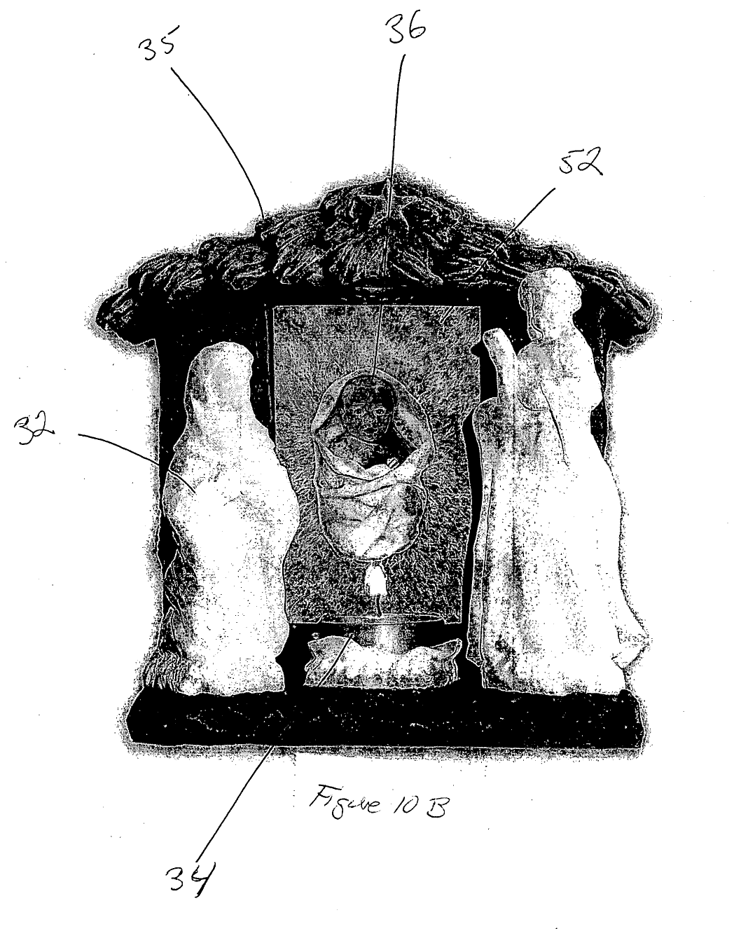

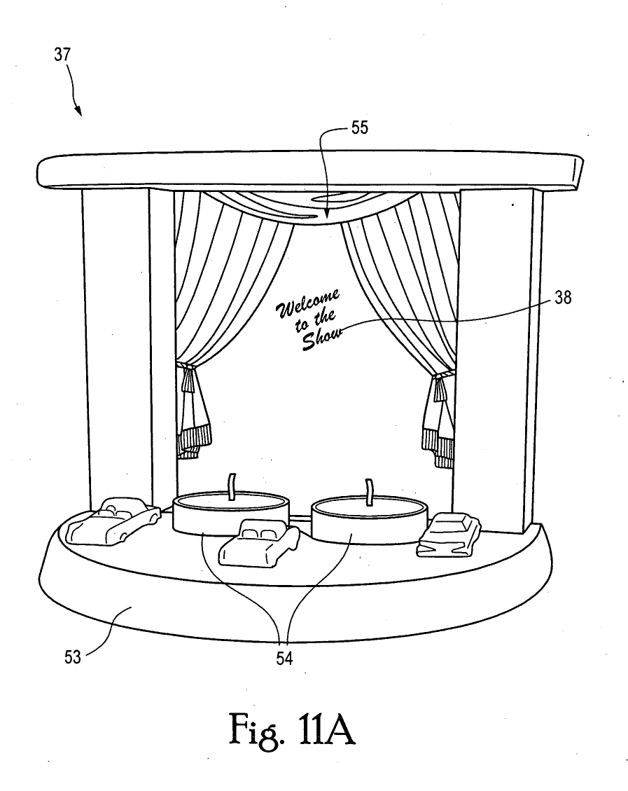

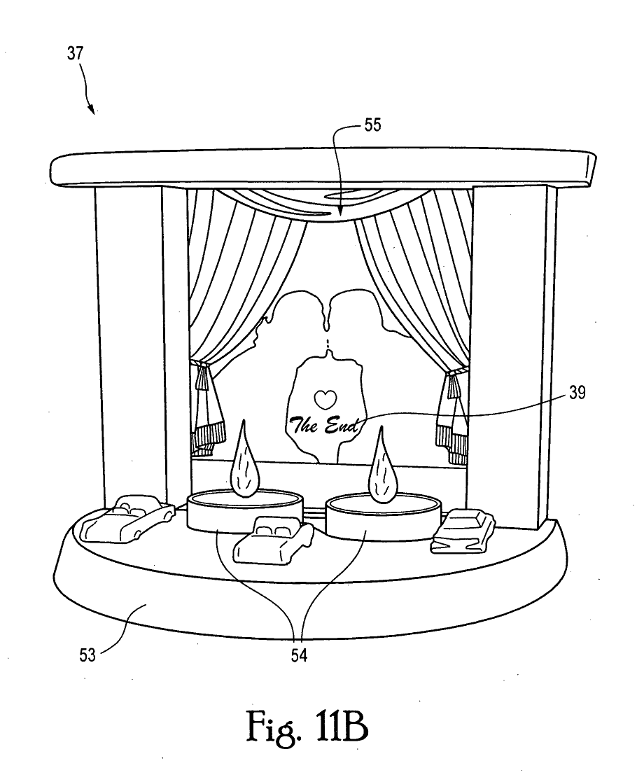

FIG. 1 shows an exploded view of the display arrangement, where each layer is shown sequentially. The substrate 10 forms the base layer along with the non-thermochromic color image 11. The second layer 12 of non-thermochromic ink(s) is shown with cut-out stenciled images 14 and 15. The third layer 13 of non-thermochromic ink(s) is shown with cut-out stenciled images 16 and 17, which correspond to cut-out stenciled images 14 and 15 of the second layer 12.

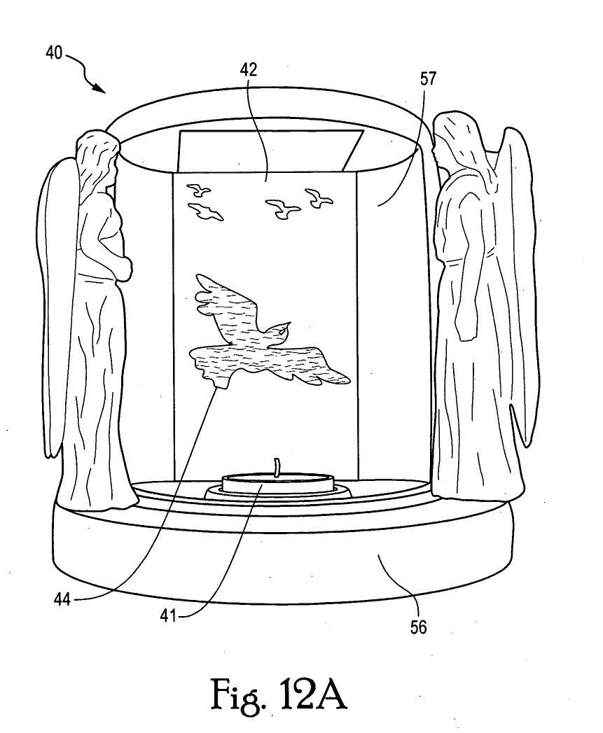

FIG. 2 shows a representative design of the visible third layer of the display arrangement 18 as it might be visible in the cold state, or at temperatures lower than the color-changing temperature for the thermochromic inks. Cut-out stenciled image 19 is shown.

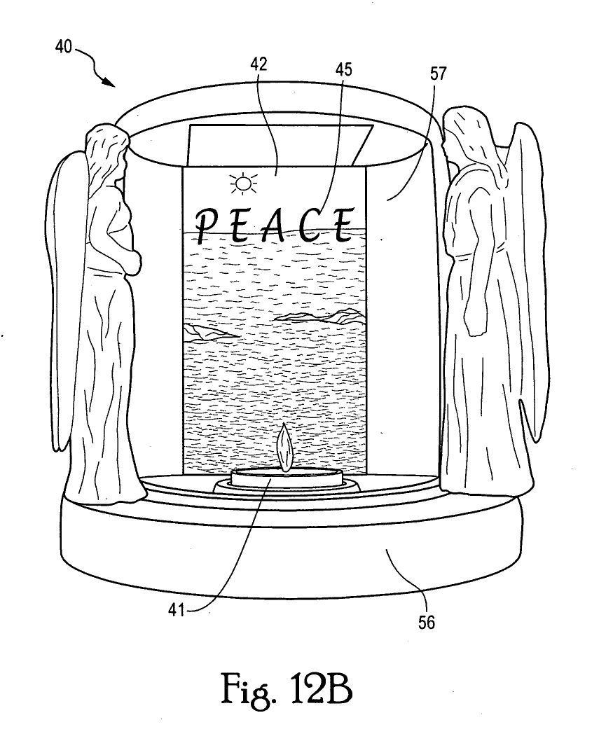

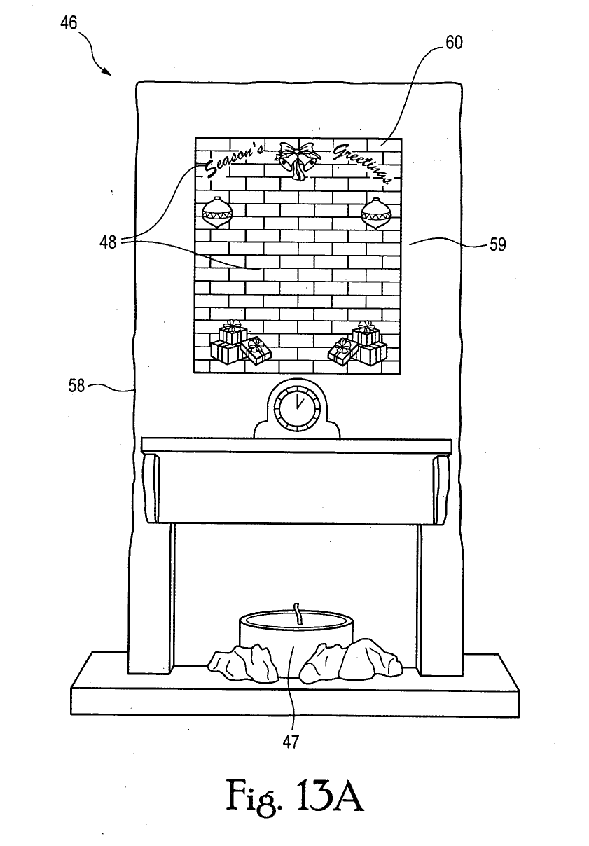

FIG. 3 shows a representative design of the visible base layer 20 of the display arrangement as it might be visible in the hot state, or at temperatures higher than the color-changing temperature for the thermochromic inks. The non-thermochromic color image of the base layer is visible. FIG. 3 is an example of the non-thermochromic color image that could be masked by the thermochromic layers of FIG. 2. In FIG. 3, the cut-out stenciled image 19 of FIG. 2 is not visible in its original configuration. In the hot state image shown in FIG. 3, the image of hay is visible; in the cold state image shown in FIG. 2 the colors making up the hay show through the cut-out stenciled images to make up the color of the camel images.

FIG. 4 shows a representative design of the visible third layer of the display arrangement 22 as it might be visible in the cold state, or at temperatures lower than the color-changing temperature for the thermochromic inks. Cut-out stenciled image 21 is shown. The image of stage curtains 62 in this figure is made of non-thermochromic inks printed onto the base layer, forming the first layer, and are visible in the cold state because it is a cut-out stenciled image.

FIG. 5 shows a representative design of the visible third layer 24 of the display arrangement as it might be visible in the hot state, or at temperatures higher than the color-changing temperature for the thermochromic inks. The non-thermochromic color image of the base layer is visible. FIG. 5 is an example of the non-thermochromic color image that could be masked by the thermochromic layers of FIG. 4. In FIG. 5, the cut-out stenciled image 21 of FIG. 4 is not visible in its original configuration.

FIG. 6 shows a representative design of the visible third layer of the display arrangement 25 as it might be visible in the cold state, or at temperatures lower than the color-changing temperature for the thermochromic inks. Cut-out stenciled images 26A and 26B are shown.

FIG. 7 shows a representative design of the visible third layer 50 of the display arrangement as it might be visible in the hot state, or at temperatures higher than the color-changing temperature for the thermochromic inks. The non-thermochromic color image 27 of the base layer is visible. FIG. 7 is an example of the non-thermochromic color image that could be masked by the thermochromic layers of FIG. 6. In FIG. 7, the cut-out stenciled images 26A and 26B of FIG. 6 remain visible in their original configuration. The non-thermochromic ink images of the “Seasons Greetings” is a cut-out stenciled images showing the ink of the first layer.

FIG. 8 shows a representative design of the visible third layer of the display arrangement 29 as it might be visible in the cold state, or at temperatures lower than the color-changing temperature for the thermochromic inks. Cut-out stenciled image 28 is shown.

FIG. 9 shows a representative design of the visible third layer 51 of the display arrangement as it might be visible in the hot state, or at temperatures higher than the color-changing temperature for the thermochromic inks. The non-thermochromic color images 30 and 31 of the base layer are visible. FIG. 9 is an example of the non-thermochromic color image that could be masked by the thermochromic layers of FIG. 8. In FIG. 9, the cut-out stenciled image 28 of FIG. 8 is not visible in its original configuration.

FIG. 10 shows a representative design of the display assembly as it might be visible in the cold state A, or at temperatures lower than the color-changing temperature for the thermochromic inks, and the hot state B, or at temperatures higher than the color-changing temperature for the thermochromic inks. In FIG. 10A, the display assembly 35 includes a support structure 32 constructed into a desired design of the figures of the Christmas nativity, Mary and Joseph. A candle 34 (unlit) is shown, placed in a heat source area. The display arrangement 52 shows the visible third layer with cut-out stenciled image 33 of stars, three wise men and camels. In FIG. 10B, the display assembly 35 includes a support structure 32, and the candle 34 is shown lit. The display arrangement 52 shows the visible non-thermochromic color image 36 of the baby Jesus. In FIG. 10B, the cut-out stenciled image 33 of FIG. 10A is not visible in its original configuration.

FIG. 11 shows a representative design of the display assembly as it might be visible in the cold state A, or at temperatures lower than the color-changing temperature for the thermochromic inks, and the hot state B, or at temperatures higher than the color-changing temperature for the thermochromic inks. In FIG. 11A, the display assembly 37 includes a support structure 53 constructed into a desired design of a drive-in theater with miniature cars and a theater screen. A candle 54 (unlit) is shown, placed in a heat source area. The display arrangement 55 shows the visible third layer with cut-out stenciled image 38 with the cut-out stencil words “Welcome to the Show”. In FIG. 11B, the display assembly 37 includes a support structure 53, and the candle 54 is shown lit. The display arrangement 55 shows the visible base layer and non-thermochromic color image 39 of the words “The End”. In FIG. 11B, the cut-out stenciled image 38 of FIG. 11A is not visible in its original configuration.

FIG. 12 shows a representative design of the display assembly as it might be visible in the cold state A, or at temperatures lower than the color-changing temperature for the thermochromic inks, and the hot state B, or at temperatures higher than the color-changing temperature for the thermochromic inks. In FIG. 12A, the display assembly 40 includes a support structure 56 constructed into a desired design of two angels flanking a display region 57 supporting a display arrangement 42. A candle 41 (unlit) is shown, placed in a heat source area. The display arrangement 42 shows the visible third layer with cut-out stenciled image 44 of birds. In FIG. 12B, the display assembly 40 includes a support structure 56, and the candle 41 is shown lit. The display arrangement 42 shows the visible base layer and non-thermochromic color image 45 of a sunrise and the word “Peace”. In FIG. 12B, the cut-out stenciled image 44 of FIG. 12A is not visible in its original configuration.

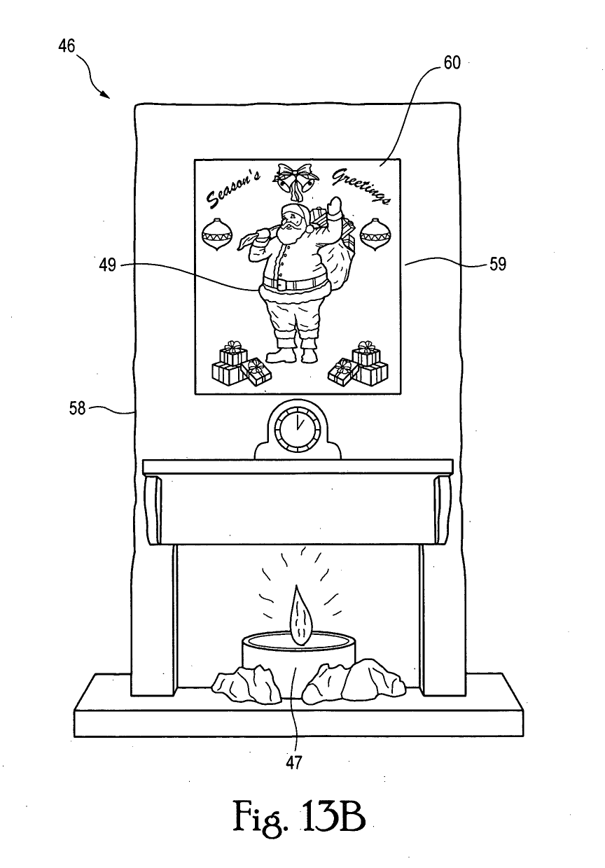

FIG. 13 shows a representative design of the display assembly as it might be visible in the cold state A, or at temperatures lower than the color-changing temperature for the thermochromic inks, and the hot state B, or at temperatures higher than the color-changing temperature for the thermochromic inks. In FIG. 13A, the display assembly 46 includes a support structure 58 constructed into a desired design of a fireplace with a display region 59 supporting a display arrangement 60. A candle 47 (unlit) is shown, placed in a heat source area. The display arrangement 60 shows the visible third layer with cut-out stenciled image 48 of a cut-out stencil brick pattern and the cut-out stencil words “Seasons Greetings”. In FIG. 13B, the display assembly 46 includes a support structure 58, and the candle 47 is shown lit. The display arrangement 60 shows the visible base layer and non-thermochromic color image 49 of a jolly Santa Claus. In FIG. 13B, the cut-out stenciled image 48 of FIG. 13A is not visible in its original configuration.

These figures are non-limiting and are exemplary of the many designs and forms of our invention. As would be understood by someone having ordinary skill in this art, many other different colored patterns, pictures or designs may be employed, all using the basic concepts of the invention as described above.

1. A display arrangement comprising
a first layer having a substrate on which is one or more colors of non-thermochromic ink including a color image;
a second layer positioned on top of the first layer, which second layer comprises a thermochromic ink;
a third layer positioned on top of the second layer, which third layer comprises thermochromic ink of at least one color, which is not the same color as the thermochromic ink of the second layer,
wherein the thermochromic ink of the second layer and the thermochromic inks of the third layer in combination are sufficient to at least significantly mask from visibility the color image of the first layer at a first temperature,
and wherein the second and third layers include at least one corresponding cut-out stenciled image so that at least part of the first layer including one or more colors is visible at the position of the cut-out stenciled images at the first temperature,
and wherein at the first temperature the color image of the first layer is at least significantly masked, and when the display arrangement is heated to a second temperature the thermochromic inks of the second and third layers become sufficiently transparent that the cut-out stenciled images are not visible as cut-out images and the color image of the first layer becomes at least partially visible,
and wherein when the display region is allowed to cool to the first temperature the thermochromic inks of the second and third layers are again visible and at least significantly mask the color image of the first layer, and the cut-out stenciled images are again visible as cut-out images.

2. The display arrangement of claim 1, which is combined with a display assembly comprising
a support shaped in the form of a predetermined object, which support has a display region and a heat source area positioned below the display region,
wherein the heat source area is shaped to receive a heat source;
wherein the display arrangement is attached to the display region.

3. The display assembly of claim 2, which further includes a heat source.

4. The display arrangement of claim 1, wherein the first layer substrate comprises polyvinyl chloride.

5. The display arrangement of claim 1, wherein the color image of the first layer has at least four colors.

6. The display arrangement of claim 1, wherein the colors of the second layer are selected from the group consisting of brown, red, black, charcoal gray, and blue-green.

7. The display arrangement of claim 1, wherein the colors of the third layer are selected from the group consisting of red, blue, brown, charcoal gray, purple, green, orange, and shades thereof.

8. The display arrangement of claim 1, wherein the colors of the third layer form a color image.

9. The display arrangement of claim 1, wherein the first temperature is ambient or room temperature.

10. The display arrangement of claim 1, wherein the second temperature is at least about 76° F.

11. A method of operating a display assembly, wherein the display assembly comprises a support shaped in the form of a predetermined object, which support has a display region, a display arrangement communicating with the display region, a heat source area positioned below the display region and shaped to receive a heat source, and a heat source communicating with the heat source area;
wherein the display arrangement comprises
a first layer having a substrate on which is one or more colors of non-thermochromic ink including a color image;
a second layer positioned on top of the first layer, which second layer comprises a thermochromic ink;
a third layer positioned on top of the second layer, which third layer comprises thermochromic ink of at least one color, which is not the same color as the thermochromic ink of the second layer,
wherein the thermochromic ink of the second layer and the thermochromic inks of the third layer in combination are sufficient to at least significantly mask from visibility the color image of the first layer at a first temperature,
and wherein the second and third layers include at least one corresponding cut-out stenciled image so that at least part of the first layer including one or more colors is visible at the position of the cut-out stenciled images at the first temperature,
and wherein at the first temperature the color image of the first layer is at least significantly masked, and when the display arrangement is heated to a second temperature the thermochromic inks of the second and third layers become sufficiently transparent that the cut-out stenciled images are not visible as cut-out images and the color image of the first layer becomes at least partially visible,
and wherein when the display region is allowed to cool to the first temperature the thermochromic inks of the second and third layers are again visible and at least significantly mask the color image of the first layer, and the cut-out stenciled images are again visible as cut-out images;
comprising the step of causing heat to be emitted from the heat source so as to heat the display arrangement to the second temperature so that the thermochromic inks of the second and third layers become sufficiently transparent that the cut-out stenciled images are not visible as cut-out images and the color image of the first layer becomes at least partially visible.

12. The method of claim 11, which further includes the step of cooling the heat source thereby allowing the display region to cool to the first temperature.

13. The method of claim 11, wherein the color image of the first layer has at least four colors.

14. The method of claim 11, wherein the colors of the third layer form a predetermined color image.

15. The method of claim 11, wherein the first temperature is ambient or room temperature.

16. The method of claim 11, wherein the second temperature is at least about 76° F.

17. A method of making a display arrangement, comprising the steps of
(i) forming a base layer by applying a color image having one or more colors of non-thermochromic ink onto a support capable of accepting ink;
(ii) applying over the base layer a thermochromic ink, to form a second layer;
(iii) applying over the second layer thermochromic ink of at least one color which is not the same color as the thermochromic ink of the second layer, to form a third layer, wherein the thermochromic ink of the second layer and the thermochromic inks of the third layer in combination are sufficient to at least significantly mask from visibility the color image of the first layer at a first temperature,
(iv) cutting out at least one stenciled image through the second and third layers so that at least part of the first layer including one or more colors is visible at the position of the at least one cut-out stenciled image at the first temperature.

18. The method of claim 17, which comprises the further step after step (iv) of applying a film sealing on top of the third layer.

19. The method of claim 17, wherein the color image is applied to the support of the base layer by offset printing.

20. The method of claim 17, wherein the thermochromic ink of the second layer is applied to the base layer by silkscreening.

21. The method of claim 17, wherein the thermochromic inks of the third layer are applied to the second layer by silkscreening.

22. The method of claim 21, wherein the thermochromic ink of the third layer is applied to the second layer by a silkscreen having a mesh of 150 openings per square inch.

23. The method of claim 17, which comprises the further step of attaching the display arrangement to a display region on a support shaped in the form of a predetermined object, which support has a heat source area positioned below the display region that is shaped to receive a heat source.

24. The method of claim 23, wherein the support is made of cold cast resin material.
